(19) United States
(12) Patent Application Publication
(10) Pub. No.: US 2005/0160022 A1
(43) Pub. Date: Jul. 21, 2005

(54) Method and system for coordinating the purchase, management, and exchange of jointly owned property

(75) Inventor: Mark Owen Chesney, American Fork, UT (US)

Correspondence Address: Attn: Christopher L. Johnson;THORPE NORTH & WESTERN, LLP, P.O. Box 1219, Sandy, UT, 84091-1219, US

(73) Assignee: Legacy Lodging, LLC

(21) Appl. No.: 11/018,855

(22) Filed: Dec. 20, 2004

Related U.S. Application Data
(60) Provisional application No. 60/531,348, filed on Dec. 19, 2003.

(51) Int. Cl. G06F 17/60

(52) U.S. Cl. 705/35

(57) ABSTRACT

The present invention features a computer-assisted method for finding or locating real property and for coordinating and administering the purchase, management, and exchange of such property within an identified community of participants. The system and business method is a combination of incentivizing real estate agent marketing support, the proprietary development of an electronic database storing and exploiting both real property and client information, a risk-mitigated purchase plan, and the implementation of coordinated, shared property use through customized covenants mutually adopted by property owners. The system is a shared equity/ownership system, with the properties preferably being high-end properties.

### RELATED APPLICATIONS

This application claims priority to U.S. Provisional Patent Application Ser. No. 60/531,348, filed Dec. 19, 2003 and entitled, “Computer-assisted Method for Coordinating the Purchase and Exchange of Jointly Owned Property,” which is incorporated by reference in its entirety herein.

### FIELD OF THE INVENTION

The present invention relates to various business methods and associated computer systems designed for the purpose of at least one of selling, purchasing, managing, and exchanging real property, and particularly to various business methods and associated computer systems designed for the purpose of providing, to an identified community of participants, services related to coordinating or managing or organizing or administrating the purchase, management, and exchange of jointly-owned property, including providing a computer network to match prospective purchasers with each other and with available property.

### BACKGROUND OF THE INVENTION AND RELATED ART

The idea of vacationing exists for any number of reasons, depending upon whom is asked, and may be described in general terms as the act of temporarily relocating yourself, your family, and/or your friends to a place of some distance from everyday circumstances and surroundings for the purpose of leaving the everyday world behind and traveling to a desired destination to enjoy the amenities, lifestyle, environment, food, culture, and people living there. To some, a vacation means receiving much needed rest and relaxation. To others, a vacation means the chance to work frustrations out, accomplish things that have gone unaccomplished, participate in various activities, spend quality and memorable time with family and friends, etc., all things that make a vacation a vacation.

It goes without saying that one of the primary needs in any vacation is lodging. Perhaps the most common type of lodging available to vacationers are hotels, motels, rental resort condominiums, and other such properties. These offer travelers significant benefits. First, they are a relatively inexpensive way to travel practically anywhere in the world. Second, they are hard to beat when it comes to convenience. For one, patrons are not required to clean or do any type of maintenance. They show up, stay, and once their time is up, they simply leave. Third, there is no long term commitment involved. A person can select any number of nights to stay and pay on a per night or per week basis without incurring any additional obligation. There is nothing owned, nor nothing received. The guests of such properties are just that, guests. This is an attractive offer for many who are only able to vacation periodically, or for those who cannot afford to or that do not want to purchase a vacation property.

A different type of lodging concept altogether involves vacationing in properties that are owned or partly owned. One alternative to hotel-type lodging includes ownership in a real estate property with the ability to “trade” or “swap” time at the property in one location for time at a property located in another location. Currently there are two predominant business concepts that exist for buying and exchanging vacation properties.

The first business concept is the conventional “time-share” concept and its many variations, all of which share at least one common thread. In its simplest form, the concept of a time share allows one person to purchase a share or interest (typically measured in units of time) in a vacation real estate property. Then, based on the purchased share, and under an agreement that others can stay in the property they purchased into, each person has the opportunity to select from a listing of other properties to stay. Thus, for a relatively small amount, the person can buy a share of a vacation property with the expectation of being able to travel to many other vacation destinations under a property exchange program. The administrators or companies offering such time-shares and managing and coordinating the property exchange program cater to those who want to travel to many destinations, but that also like to own vacation real estate. The traditional time share concept provides this. However, there are some significant downsides to owning a time share in a vacation property. First, only a few limited time periods are offered to purchasers/owners in which they can stay in the property, as it must be made available to other time share owners or those who have negotiated an exchange. Second, the exchange program can be extremely frustrating as it is often difficult to find a desirable exchange, particularly in the destination you want at the time you want. Third, the vacation properties themselves are typically modeled after or are comprised of condominiums that provide several units within a single structure. Such an arrangement where many others will likely be around can be very unappealing to some. Fourth, timeshare vacation properties tend to be small. Again, this may not suit many looking for more spacious and more private properties. Fifth, real estate interests sold arise from interest previously acquired or constructed on a speculative basis. These interests sold are from previously existing inventories. Sixth, the sales prices of timeshare interests reflect costs needed for project owners to recover all carrying expenses, investments, and a desired return on investment.

The second, and more recently developed concept, is the “residence club” concept. This business model is typically distinguished by cost-effective acquisition of high-end real-estate made possible by cooperative means. Use rights are secured, certified, and property use is shared by program participants. Title to real-estate is typically held in a charter property. Notwithstanding, use may be provided in numerous properties within a portfolio. The possibility of fully realizing the benefits of equity, particularly as pertaining to re-selling, are typically non-existent. This concept, while providing participant's the ability to obtain more luxurious vacation properties, lacks in administration aspects from a buyer's standpoint. Further, the residence club concept obtains and develops its client base in a way similar to the timeshare model.

Based on the deficiencies in these two concepts, a distinctive market has emerged for purchasing vacation real estate in a non-traditional manner. It is characterized by vacationer demand for more luxurious, spacious, private, comfortable living environments with resort amenities in close proximity. It is also characterized by demand for more a more personal sense of ownership of and control over the property, as well as the desire for added flexibility and increased benefits. The emergence the demand for such a market has been influenced by several things, including tax laws that are more favorable to owners of high-end vacation real estate property, and the preference for the baby boomer generation, as well as middle to high income earners, to distance themselves from younger, less affluent vacationers, such as the generation X demographic, which is the largest and fastest growing segment of the population buying timeshare interests. In essence, traditional time shares and other similar concepts, while appealing to many, do not cater to the needs or desires of many individuals.

Only four percent of the certain demographic suited for the present invention system has been tapped. This is true despite the fact that vacation homes sales have exploded in growth in recent years. One principal reason for such increases was due to IRS changes in the tax code that permitted sellers to exclude up to $500,000 in capital gains from taxation. This change facilitated selling primary residences and using proceeds to buy a smaller residence and a second vacation home.

Vacation homes are especially attractive to the growing number of baby boomer families in the “empty nest” phase of their lives. The median age of second-home buyers is causing expectations of adding 100,000 to 150,000 units to housing starts each year between 2000 and 2010. Clearly, people are purchasing in larger numbers and at higher prices. However, they want more choices and they want a better system for purchasing that makes the decision more economical, more practical and less risky. High income Americans are statistically passing on opportunities to buy timeshares as the timeshare concept does not fit their social and vacation preferences.

The growing desire for spacious, private dwellings where outdoor recreation is indigenous is also evidenced through a combination of other important findings: 1) where vacationers feel forced to buy timeshares, the largest percentage of such purchases are located where the number of units is as few as possible; 2) baby boomers and matures especially do not prefer lodging where common areas are shared and privacy is jeopardized; 3) these individuals are much more apt to select vacation destinations where the following activities can be engaged in by close proximity: beach/waterfront activity, touring/site seeing, shopping, snow skiing and golfing.

### SUMMARY AND OBJECTS OF THE INVENTION

The present invention seeks to overcome the deficiencies in prior related business concepts and/or methods by featuring a computer-assisted method for coordinating the purchase and exchange of jointly owned property. It is noted herein at the outset that the present invention business method is not a time-share concept nor does it rely on or comprise the elements that make up a time-share system or method. Rather, the present invention utilizes a different approach. Generally, the present invention comprises an administrative group that utilizes various unique concepts to partner individuals in the joint-purchase of high-end real estate properties, typically for vacation purposes. This is preferably done using a transactional activity center in the form of an online computer network, wherein prospective purchasers and properties are aligned and associations formed, such as associations with real estate brokers and others. The present invention further features a unique assisted purchase concept or technique, as well as a unique property exchange program, each of which are not found in prior related business methods or models, and more especially a time-share model. Essentially, the present invention improves on prior related business methods of providing vacation properties to vacationers and others by providing a proprietary system or method for facilitating the joint purchase by at least two individuals of spacious, luxurious, and well-appointed vacation properties. The administrative group may be strategically aligned with various brokers to locate and arrange for the purchase of vacation properties. Once certain properties become available for purchase, the administrative group assists purchasers in identifying homes for prospective purchase. Several criteria are used to match a buyer with another buyer and a buyer to a vacation property, such as in-depth market research and any preferences stated by the buyer(s). The vacation properties are selected by the prospective purchasers, and a property purchase is made jointly by a small number of buyers, thus allowing each to enjoy a more luxurious vacation property. Use of the property purchased in facilitated by the administrative group and shared between the purchasers on a coordinated and agreed upon basis.

As such, it is an object of some of the exemplary embodiments of the present invention to provide a method for coordinating the purchase and exchange of property.

It is another object of some of the exemplary embodiments of the present invention to provide a system database that is network accessible to match prospective purchasers with other prospective purchasers and properties.

It is still another object of some of the exemplary embodiments of the present invention to form strategic alliances with real estate agents and brokers and others to find and procure or acquire real estate or property.

Although several objects of some of the various exemplary embodiments have been specifically recited herein, these should not be construed as limiting the scope of the present invention in any way. Indeed, it is contemplated that each of the various exemplary embodiments described comprise other objects that are not specifically recited herein. These other objects will be apparent to and appreciated by one of ordinary skill in the art upon practicing the invention as taught and described herein.

To achieve the foregoing objects, and in accordance with the invention as embodied and broadly described herein, the present invention features a method and system for finding or locating real property and for coordinating and administering the joint-purchase, management, and exchange of such property within an identified community of participants. In one exemplary embodiment, the method comprises (a) forming strategic alliances with one or more real estate brokers for the finding and acquisition of real property; (b) providing incentives to the real estate brokers for their services; (c) establishing a computer network having a database of prospective purchasers, purchasers, and properties and information related to these; (d) matching prospective purchasers with each other and at least one property to be jointly owned by the prospective purchasers; (e) coordinating and managing the sale and purchase of the property; (f) establishing an entity through which the joint owners in the property hold title to the property; (g) coordinating the establishment of customized covenants to govern use and ownership of the property between the joint owners; and (h) coordinating and managing the exchange of properties between purchasers and others.

The system and method is a combination of incentivizing real estate agent marketing support, the proprietary development of an electronic database storing and exploiting both real property and client information, a risk-mitigated purchase plan, and the implementation of coordinated, shared property use through customized covenants mutually adopted by property owners. The system is a shared equity/ownership system, with the properties preferably being high-end properties. Moreover, joint-owners have the ability to control their interests and to do with them as they see fit, such as offer them for sale, rent them to others, etc.

As part of the exemplary system, a person registers on the web site to participate in the program and become a prospective purchaser and to utilize the system. Registering involves providing various information for later use, as well as selecting a luxury vacation home in a particular location and the time of year the person would like to vacation. The prospective purchaser's demographic and prioritized vacation home information is entered and stored in a computer database accessible by a computer network (e.g., Internet accessible). The database further comprises a list of potential suitable properties. The computer database functions to provide an electronic interface between clients, prospective purchasers, real estate brokers, and administrators of the present invention program. Each prospective purchaser is then matched with other prospective purchasers to form a group of prospective joint purchasers, each of which will own a share of a selected property. The present invention includes coordinating the work needed to address the several issues related to the purchase of property, including, but not limited to, site selection, assembling of prospective purchasers, managing the closing of the property, etc. Once a group is assembled and sufficient interest in a particular property is shown, all of the necessary tasks for purchasing the property are taken care for the purchasers, including document preparation, disclosures, financing, taking care of all necessary closing requirements, and property management after the closing occurs, if desired by the owners. Alternatively, through prior arrangement with the seller of the real-estate, prospective purchasers may be identified through the processes described and real property interests sold and purchased separately. Under this exemplary method, the multiple, individual transactions staged progressively over time will likewise culminate with a jointly owned property as previously referenced and discussed herein. Essentially, the service provided is from start to finish for high-end, shared real property purchases, wherein the service includes 1) identifying suitable property, 2) pooling interested parties, 3) placing the property under purchase contract, 4) closing the transaction, and 5) coordinating use and management of the property.

Ownership of the property is private and held as Tenancy in Common or under some other form agreeable to the purchasers. The owners' interest and use of the property is entirely under the owners' control, subject to the agreed upon covenants that are also selected by the group of owners.

It is contemplated that each owner of a particular property will be given a certain amount of time in which to use the property. This time may be traded with owners of other properties so that each owner may have access to any number of properties at several different locations.

For each purchase, the owners agree to pay a percentage of the total purchase price, or some other compensatory sum, to the program administrators as a fee for their services.

Another unique aspect of the present invention involves the close association with real estate agents and brokers to find, promote, and purchase various properties. It is contemplated that the real estate brokers will receive a commission amount based on a percentage of the purchase price of any properties purchased as a result of their efforts (i.e., a referral fee). As part of their association, each real estate broker will have the opportunity to host their own website that includes a link to the program website hosted by the program administrators.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a flow diagram representing an exemplary process of locating approved or qualifying real-estate properties;

FIG. 2 illustrates a flow diagram representing an exemplary process of qualifying prospective purchasers and compiling an associative database;

FIG. 3 illustrates a flow diagram representing an exemplary process of coordinating the purchase of real-estate;

FIG. 4 illustrates a flow diagram representative of an exemplary purchase process for a plurality of prospective purchasers to become joint owners in a property;

FIG. 5 illustrates a flow diagram representing an exemplary process of forming one or more strategic alliances with real-estate brokers/agents;

FIG. 6 illustrates a detailed diagram of an exemplary incentive arrangement provided to an affiliate real-estate broker/agent, wherein the real-estate broker/agent personally refers a potential client to administrators;

FIG. 7 illustrates a detailed diagram of another exemplary incentive arrangement provided to an affiliate real-estate broker/agent, wherein the real-estate broker/agent owns and/or operates his or her own web site or web page within a web site;

FIG. 8 illustrates a diagram of an exemplary computer network configuration for providing a transactional activity center; and

FIG. 9 illustrates a data structure of various exemplary databases that may be compiled and stored on the server system owned and operated by administrators.

### DETAILED DESCRIPTION OF EXEMPLARY EMBODIMENTS

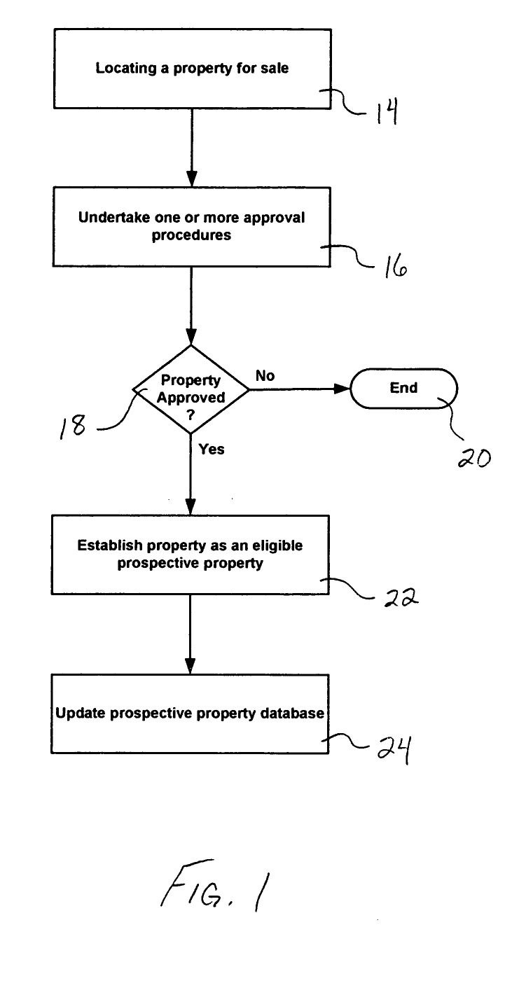

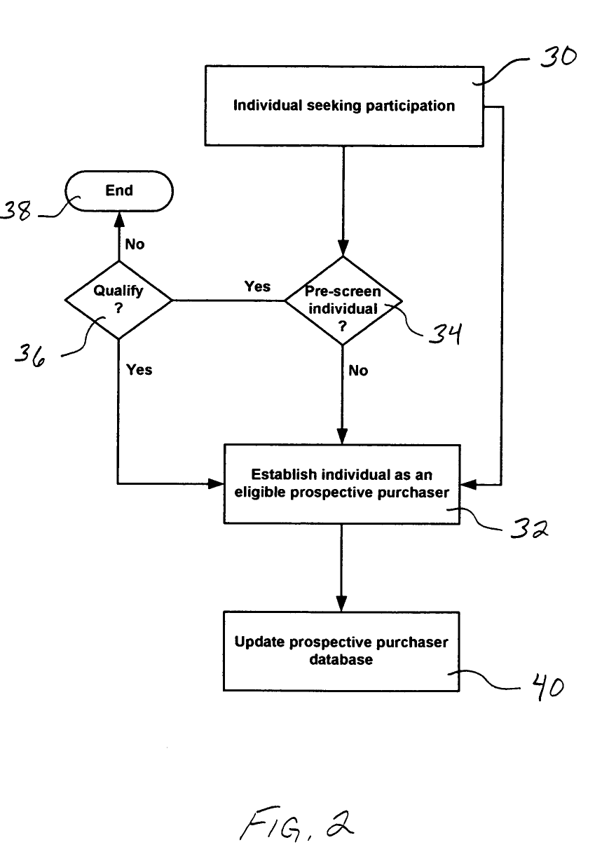

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 9 is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout. The following detailed description is also divided into sections for convenience to the reader. These sections are not intended to limit the invention in any way, as the features or concepts described in the various sections are intended to be utilized with, and therefore incorporated into, the features or concepts described in the other sections, unless indicated otherwise.

### Definitions

The following definitions are provided for clarification purposes of several of the terms and/or phrases used herein.

Preliminarily, the phrase “prospective purchaser,” and similar phraseology, as used herein, shall be understood to mean the status of an individual qualified and approved by administrators to enter into the joint ownership of a real estate property with one or more other prospective purchasers, but who has not done so yet.

The term “owner,” and similar terminology, as used herein, shall be understood to mean a prospective purchaser that has elevated his status by establishing himself as a joint owner in a real estate property. The term “owner” is used synonymously, herein, with the term “purchaser.”

The phrase “ownership group,” and similar phraseology, as used herein, shall be understood to mean the plurality of joint owners or purchasers of a real estate property, as obtained under the present invention system, with each owner having a shared equity interest in the property.

The phrase “prospective property,” and similar phraseology, as used herein, shall be understood to mean a property that is not yet available for purchase, but that may become available upon qualifying.

The phrase “available property,” and similar phraseology, as used herein, shall be understood to mean a property that is immediately available for joint purchase by a plurality of prospective purchasers.

The term “administrator,” and similar terminology, as used herein, shall be understood to mean the individual, group of individuals, entity, or entities operating the present invention method and system as a business for profit.

The phrase “Disclosure Memorandum,” and similar phraseology, as used herein, shall be understood to mean the documentation provided by administrators that sets forth the purchase offer and general risks associated with the joint purchase of real estate.

The phrase “Services Agreement,” and similar phraseology, as used herein, shall be understood to mean the documentation provided by administrators that sets forth the manner of compensation to be provided to administrators from the sale of the property to the prospective purchasers.

The phrase “Declaration of Covenants,” and similar phraseology, as used herein, shall be understood to mean the documentation provided by administrators and agreed upon by the ownership group that sets forth the governance and management of the property. The phrase Declaration of Covenants is intended to be used synonymously with Operating Agreement.

### System for Coordinating the Purchase, Management, and Exchange of Jointly-Owned Real Estate

Stated generally, the present invention describes and features a computer-assisted system and method for coordinating the purchase, management, and exchange of jointly owned real estate properties, which real estate properties are preferably private, spacious, and well-appointed vacation properties that are typically located in resort areas or areas featuring desirable outdoor recreation and distinctive culture or entertainment.

The present invention system and method is carried out by an administration team that may comprise various sub-teams. First and foremost, administrators assist prospective purchasers in identifying real estate properties or vacation properties which prospective purchase may wish to jointly own, and do so on the basis of various criteria or information, such as market research, stated preferences, availability, location, price, number of owners, etc. Once a profile is created and stored for a prospective purchaser, administrators match the prospective purchaser with other prospective purchasers that may also be interested in joint ownership of one or more properties. An ownership group is formed when two or more prospective purchasers select an available or prospective property for purchase. As such, the purchase of a property is made jointly by a small number of prospective purchasers. An ownership group will typically comprise four to seven owners or purchasers.

Administrators will preferably be compensated on a pre-determined basis, which will typically result in monetary compensation comprising a percentage of the purchase price of the vacation property, as well as non-monetary compensation in the form of usable time in the property. The premise for charging fees is quite simple. The centralized services provided by administrators of the present invention accomplish for clients what would be highly impractical, if not impossible, to accomplish if attempted by the client himself. Moreover, many clients do not wish to perform many of the required needs. The monetary compensation is generally in the form of a fee that is preferably competitively set in comparison to standard commercial real estate syndication services. The range of 4-6% is common. The fee of 4% on the property purchase price (likely 1% by each of 4 partners on the assumption there are 4) may be set, but may also be subject to further perpetual review. This fee structure features a downwardly graduating scale relative to the purchase price. For example, a property purchase price of up to $2 million carries a services fee of 4%. A property purchase price between $2 million and $5 million carries a fee of 3%.

Prior to commencement of services offered to prospective purchasers and purchasers, it is intended that the prospective purchaser sign a Services Agreement. This agreement explains the fees to be charged and further requires that a fee will be assessed for the services rendered.

Non-monetary compensation may include retaining a fractional interest in the property at the time of closing, which interest may be controlled by administrators as they see fit. This interest is acquired and retained without cost to the owners of the purchased property. Property ownership, property use and rights of equity are therefore proportionately owned by investors.

The justification for acquiring and retaining a small fractional property interest is based on the management services provided by administrators. Additionally, continuity, accountability and amicable relationships are also made secure. The amount of fractional interest acquired and retained is dependent on the number of partners in a property purchase.

Once the property is under contract, use, exchange and management of the property will be overseen and handled by administrators, with the exchange being done on a coordinated basis throughout each year. For persons desiring to jointly own vacation property, the present invention method and system functions to perform numerous, complicated (and almost prohibitive) tasks a person may be discouraged from undertaking individually.

More specifically, the present invention comprises and facilitates the joint purchase of real estate property by an ownership group. Properties are purchased and legally owned by an entity, such as an LLC, created specifically for the purchase of the property by the ownership group. The plurality of partners/owners/members may pay into the entity, thus acquiring a split equity interest in the real estate property. Although not necessary, the equity interest acquired will most typically correspond to each owner's contribution. The split interest may be based on other criteria as determined prior to purchase of the property.

Each “partner” or “owner” in the ownership group will hold legal title and equity to the purchased property through his or her interest in the created entity. For example, in an equal contribution-based purchase transaction, if a $1,000,000 property is acquired by four partners, with each purchasing a one-quarter interest through a designated and established LLC, each partner will be required to pay $250,000. In addition, use or occupancy of the property is split equally four ways as agreed upon by the partners. Additional services may be provided by administrators, including the overall property management and governance of use, and the exchange of the property between purchasers throughout the program and others. Each of these will be spelled out in the ownership agreement.

Financing for purchasers may be independently obtained or through an affiliate of administrator's, such as administrator's affiliation with investors. These investors may receive a return-on-investment in the form of installment payments or use of the various properties for a pre-determined amount of time. Other financing scenarios are contemplated and will be obvious in light of the disclosure herein.

Administrators of the present invention system are equipped to carry out and manage all system operations, including, but not limited to, operating the transactional activity center, locating properties, compiling a list of prospective purchasers (preferably, whom are pre-screened), compiling a list of available properties, marketing the system and any available properties, matching available properties with prospective purchasers, assisting in the formation of a suitable owning entity, organizing, overseeing, and conducting the purchase of properties on behalf of the prospective purchasers, managing use and exchange of the properties for the various ownership groups, forming strategic alliances with real estate brokers, servicing all client needs, etc. Example services that the administrator's will likely perform for clients include, property screening and selection, document preparation, adequate and proper disclosures, financing assistance, and property management. Property management includes adequately insuring the properties, maintaining the properties, paying all utilities and taxes, coordinating the exchange and shared use of the property, and seeing to all other aspects of general property management. Typically, all decisions regarding the use, maintenance, and repair of the property will be under the control of the ownership group, but will be carried out by administrators. However, if so desired, the ownership group may leave everything up to the administrators. Administrators will also be responsible for developing, maintaining, and operating the transactional activity center, which is preferably an online electronic database comprised of potential suitable properties and prospective purchasers who are prepared and qualified to enter into such a purchase. Each of these concepts is discussed in greater detail below.

An implementation of one exemplary embodiment of the present invention business method may be found in the GrandShare™ system owned and operated by Legacy Lodging, LLC, of Utah, which function as administrators of the GrandShare system.

### A. Locating Approved or Qualifying Real Estate Properties

The present invention system comprises locating real estate properties for purchase by two or more joint owners. These properties may be located anywhere in the world, and may comprise any price. Preferably, however, the properties used in the system will be high-end, more luxurious properties. Although the price for a property may vary significantly based on its location, a minimum price may be used for determining whether a real estate property qualifies for use within the system. An exemplary way to determine a minimum price is if such a price will purchase a qualifying property in at least 50 percent of the desired locations. In other words, if the minimum price set is $500,000, this price will be sufficient to purchase a qualifying property in at least 50 percent of the locations desired by prospective purchasers. Of course, the minimum price may be determined using other methods or different numbers, as will be obvious to one skilled in the art. It is recognized that the minimum standard may change with time due to inflation, market demands, etc. There is typically no upper limit. However, there will be a reasonable range established, including an upper and lower limit, that will serve as a guideline for prospective properties.

Prospective properties may comprise any type, such as single-family dwellings, condominiums, town homes, lodges, etc., with single-family dwellings being the most sought after type due to their stand-alone independence (e.g., they are not part of a multi-unit structure).

With reference to FIG. 1, and particularly step 14, prospective properties may be located using any known means, such as searching various multiple listing services (MLS), searching newspaper or magazine ads, utilizing real estate brokers and agents, obtaining real-estate publications, through word of mouth, individual research and investigation, any combination of these, as well as any others known in the art. Administrators perform the function of locating suitable properties and providing these properties to prospective purchasers as described herein.

Once a suitable property is discovered, administrators may approve the property as a prospective property by undertaking any one of several approval procedures, step 16. For example, administrators, or their agents, may travel to the property to perform an inspection. In any event, each property is to be approved before identified as a prospective property. During the approval procedure, it is determined, step 18, whether or not the property meets approval. The property may be judged according to pre-determined criteria, or it may be judged on an as needed basis. If the property is not approved, step 20, then there is no further activity taken with regards to the property. However, if it is approved, then the property is established as an eligible prospective property, step 22. At this time, or some determinate time in the future, the prospective property database is updated, step 24. Compiling and updating of the prospective property database may be done as often as necessary.

### B. Qualifying Prospective Purchasers and Compiling an Associative Database

The present invention system and method relies upon a successful compilation of prospective purchasers that are willing to enter into joint ownership of a real estate property. These prospective purchasers are vital in realizing the joint ownership of property through the present invention system. The client relationship formed with administrators of the system through the purchase process becomes the foundation for the future growth and success of the system.

As indicated above, there are several individuals and families looking for alternatives to time share and/or residence club concepts. These are rather affluent individuals looking for more private and more luxurious accommodations when vacationing, but that also do not want to purchase an expensive property by themselves that will only be used for a limited time throughout the year. Partnering up with one or more others in the joint ownership of a vacation property allows all to realize their goals, and at a much cheaper price.

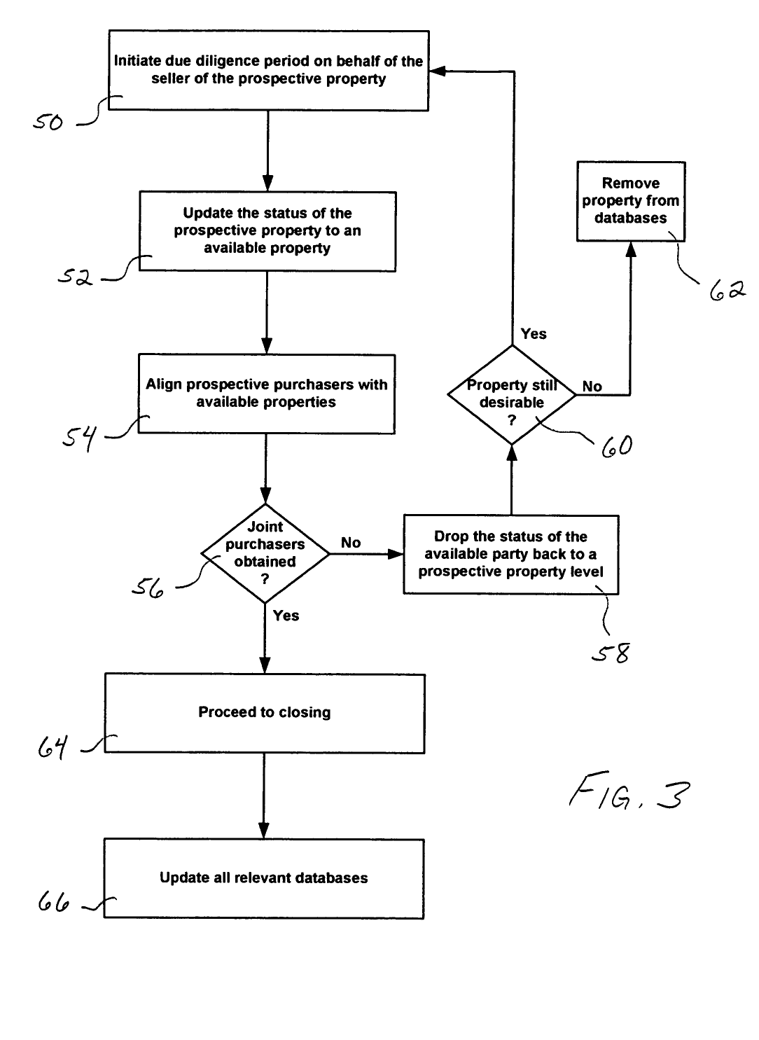

With reference to FIG. 2, and particularly step 30, individuals are desired that seek participation in the present invention property ownership system. Once an individual shows interest in becoming a joint owner in a real estate property, and administrators approve, the individual is established as an eligible prospective purchaser, step 32. A prospective purchaser may be any person interested in acquiring a split equity interest in a real estate property.

Although not necessary, before an individual is allowed to be eligible as a prospective purchaser, he/she may be subject to a pre-screening procedure, step 64, to further assess the individual qualification and/or risk-mitigation purposes. A pre-screening procedure may be in place to protect existing clients, the administrators, as well as the integrity and reputation of the system. The pre-screening of an individual is used to determine the eligibility of the individual to become a prospective purchaser, step 36. The pre-screening procedure may include several inquisitions, such as a background check, age and identification verification, a credit check or credit history check, an investigation into current and past financial standing, type of employment, available wages and salary, net worth, owned assets, etc. The pre-screening may also include less intrusive inquisitions, such as the individual's level of seriousness, what types of properties are being sought and in what locations, the number of desired partners interested in taking on, any preferred price ranges, the number of days vacationed on an annual or other basis, and any other similar inquisitions. If an individual does not pass the pre-screening phase, step 36, they are notified of such and are denied participation in the present invention ownership system. If an individual does pass, see step 36, the individual is established as an eligible prospective purchaser, step 32. After one or more individuals become prospective purchasers, the associative data base of compiled and stored prospective purchasers is updated, step 40. Compiling and updating of the prospective purchaser database may be done as often as necessary.

The client relationship formed through the above-described process, as well as the purchase process, becomes the foundation for future, possible business activity including, 1) real estate financing and property insurance; 2) property furnishings procurement; 3) guide services; and, 4) facilitation of shared-acquisition of other assets including, watercraft, aircraft and vehicles.

### C. Coordinating the Purchase of Real Estate Properties

Once one or more prospective purchasers and/or one or more prospective properties are established, the present invention provides for the coordination of the joint purchase of the prospective properties by two or more prospective purchasers. It should be noted herein that the order of obtaining and aligning prospective purchasers and prospective properties is not crucial, nor is the time in which properties are held out for sale of split equity interests. Indeed, in one exemplary embodiment, prospective purchasers may be registered as such, stored in the prospective purchaser database, and in the process of a continual and ongoing search for a suitable and desirable real estate property, or suitable and desirable joint owners. There may be properties available, but these may not suit the prospective purchaser(s), in which they may keep monitoring the system database through the transactional activity center, or request to be contacted when new properties become available. In another exemplary embodiment, prospective properties may be obtained or established without having enough prospective purchasers to execute the necessary transactions. In this case, the properties may be advertised or otherwise featured in the transactional activity center for as long as necessary until an adequate number of prospective purchasers become interested in the property. In yet another embodiment, the prospective properties may be held out to the public, such as being placed on one or more multi-listing services, advertised in various newspapers or real estate publications, etc., in hopes to attract potential purchasers. Any interested parties may still be required to go through the necessary procedures to become eligible as a prospective purchaser prior to making a purchase or entering into any agreement with administrators or other prospective purchasers. In still another exemplary embodiment, the prospective purchasers may be made known to the public in hopes to attract additional prospective purchasers.

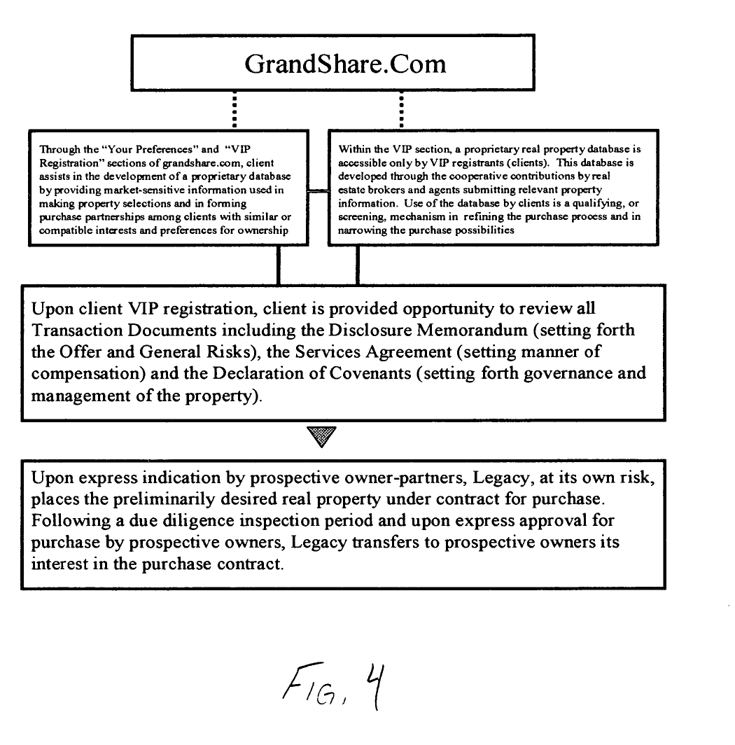

With reference to FIG. 3, and according to another, yet preferred, exemplary embodiment, administrators enter a due diligence period (typically 30 days, but may be longer or shorter) in which they hold themselves out to the prospective purchasers and the public as the seller of split equity shares in the subject property, step 50. The status of the prospective property is elevated to an available property level, step 52 for the duration of the due diligence period. During the due diligence period, prospective purchasers may be aligned or matched for joint ownership of the available property, step 54. If enough interested prospective purchasers are obtained and wish to purchase the available property, step 56, the due diligence period is terminated and the parties proceed to closing, step 64. In the event that no agreement to purchase is reached or if not enough prospective purchasers are matched, step 56, the status of the available property is dropped back to prospective property, step 58. At this time, it must be determined if the property is worth maintaining as a prospective property, step 60. If so, another due diligence period may be initiated at some time in the future, step 50. If not, the property is removed from the proper databases, step 62. With the sale of a prospective property, or removal of a prospective property from the system, all relevant databases updated to reflect the change, step 66.

Alternatively, through prior arrangement with the seller of the real-estate, prospective purchasers may be identified through the processes described and real property interests sold and purchased separately. Under this exemplary method, the multiple, individual transactions staged progressively over time will likewise culminate with a jointly owned property as previously referenced and discussed herein.

Completing the sale transaction of the available property and effectuating closing is undertaken by administrators for and on behalf of the prospective purchasers. Administrators attend to all of the details of the closing, including, but not limited to, documentation, processing, data collection and reporting, financing, insuring, etc. It is noted that traditional financing may be unlikely where property is fractionally owned. Therefore, administrators may be equipped to provide information on alternative means of financing, if necessary. However, it is of paramount importance to protect the property interests of all partners. As such, administrators will take or require measures toward ensuring the protection of all individual property interests.

Once closing is complete, the status of each of the prospective purchasers is elevated to owner, with the plurality of owners collectively comprising an ownership group.

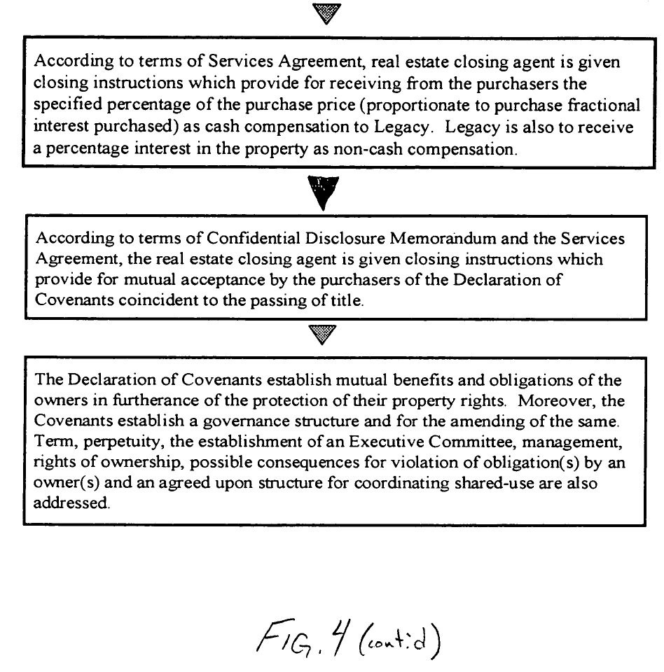

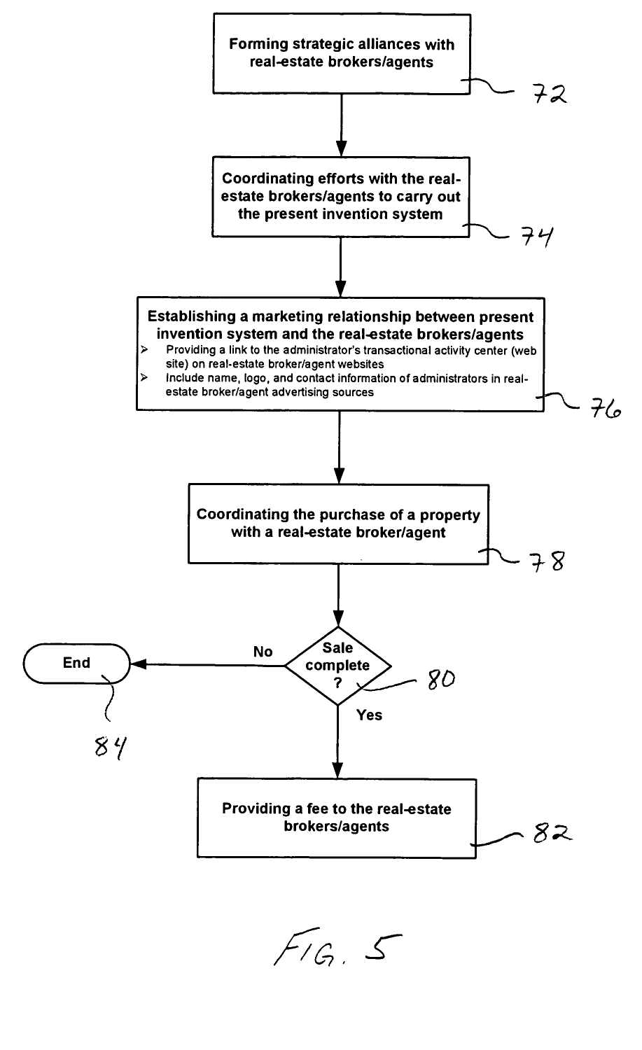

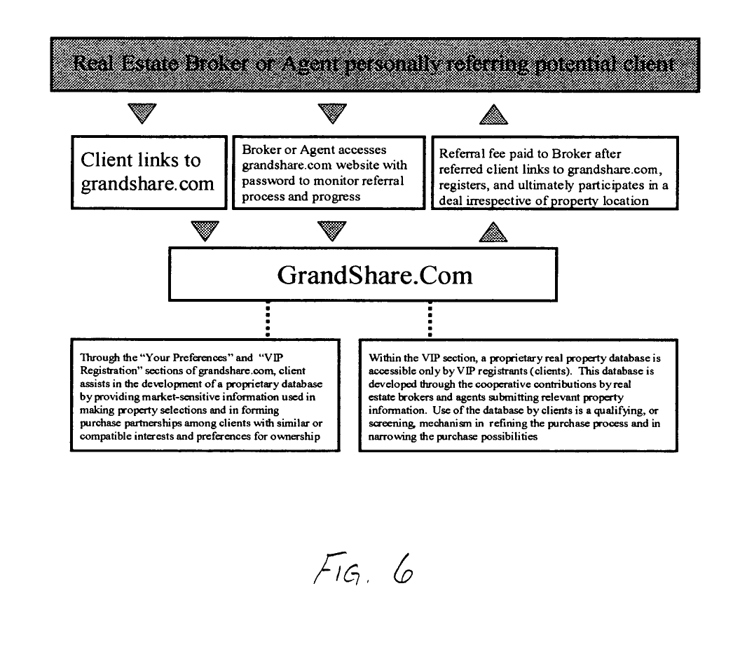

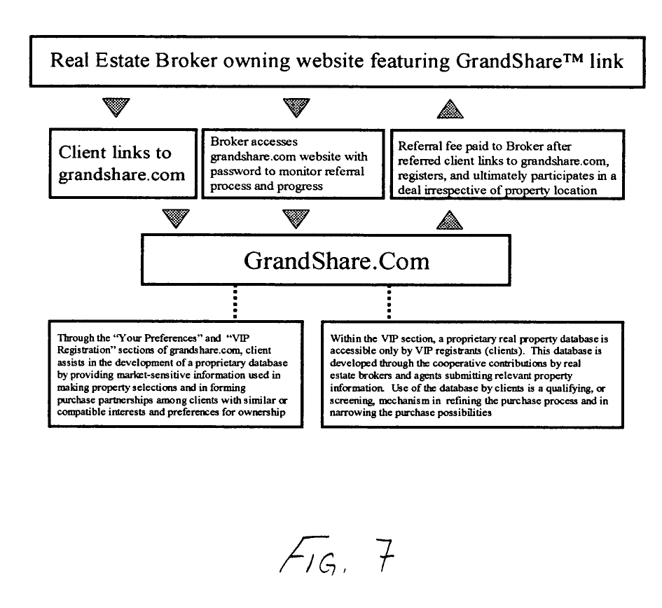

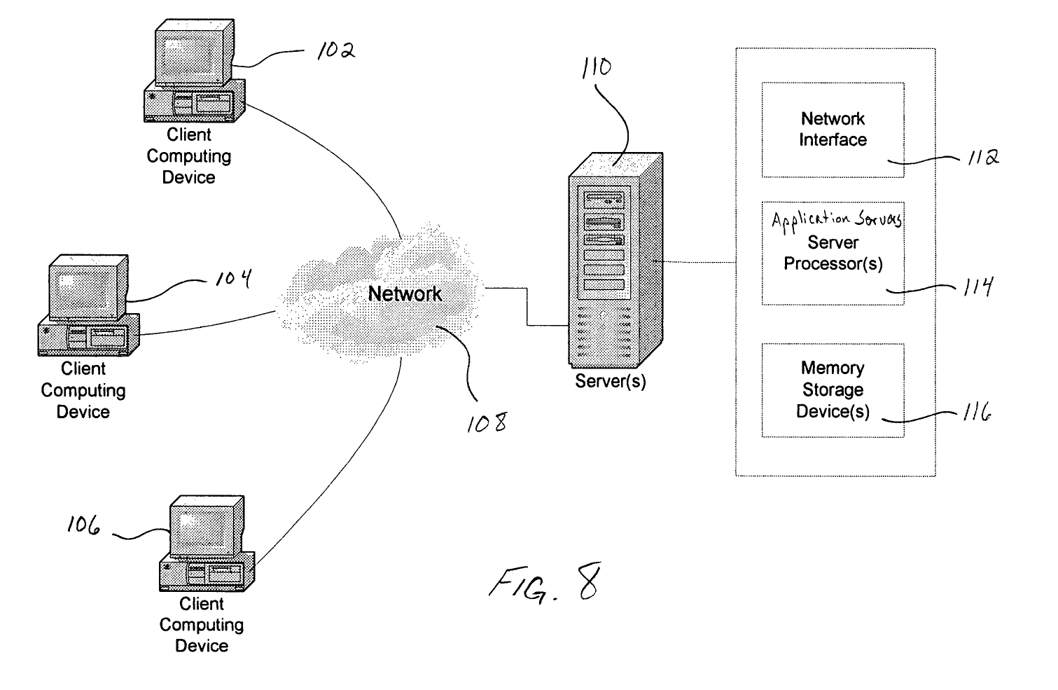

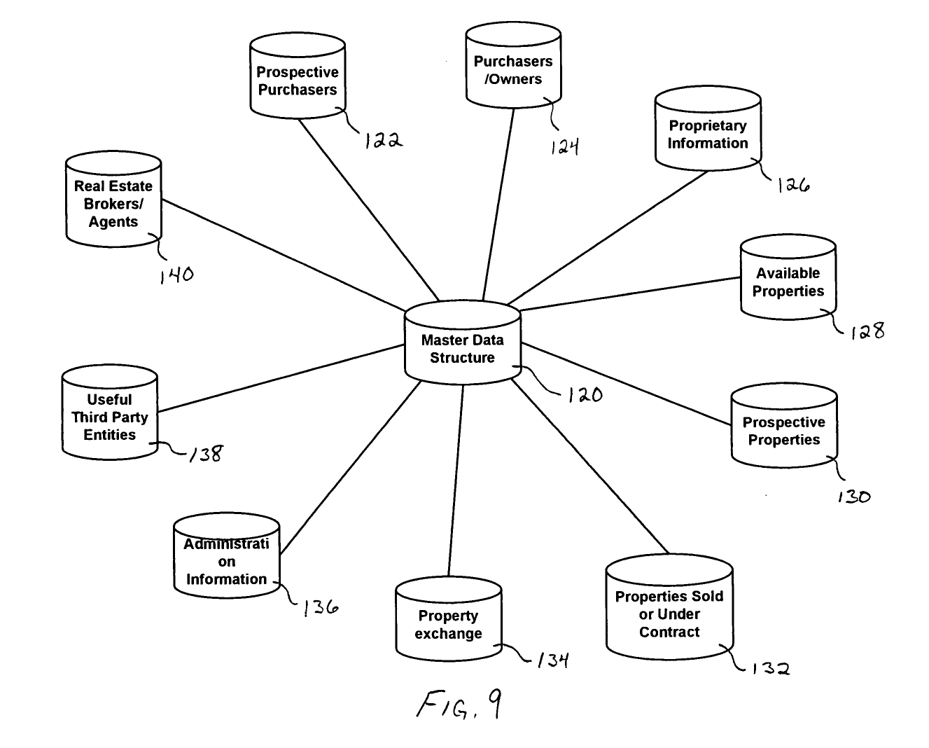

With reference to FIG. 4, illustrated is a flow diagram of an exemplary purchase process for a plurality of prospective purchasers to become joint owners in a property. This exemplary process is facilitated by the interested parties accessing the transactional activity center, shown as grandshare.com. From the transactional activity center, prospective purchasers, who have registered with the system, access the private side of the transactional activity center. Each prospective purchaser assists in the development of a proprietary database by providing market-sensitive and other information used by administrators in making prospective property suggestions or selections, and in aligning and/or partnering the prospective purchaser with other prospective purchasers having similar or compatible interest and preferences for ownership.

Within the private side of the transactional activity center, proprietary prospective property and available property databases are constructed and accessible only be existing and registered clients or prospective purchasers, as well as by administrators. These databases, which may be combined into a single property database, is developed through the cooperative contributions of real-estate brokers/agents submitting relevant property information, by administrators and their efforts to supply applicable property information, and by other means. Providing prospective purchasers access to the property database(s) functions as a qualifying or screening mechanism to further refine the purchase process and narrow and define the purchase possibilities.

Upon registration, each prospective purchaser is granted access or the opportunity to view all relevant documents pertaining to the purchase transaction. These include, but are not limited to, the Disclosure Memorandum, the Services Agreement, and the Declaration of Covenants.

Upon indication by prospective purchasers, administrators may, at its own risk, place the prospective or available property under contract for purchase. At this time, a pre-determined time period of due diligence is in effect in which any inspections or investigations may be performed, any necessary approvals may be obtained, any problems may be addressed, etc. that may affect the purchase of the property by the prospective purchasers. At the close of the due diligence period, and if no further problems or issues need to be resolved, administrators transfer to the prospective purchasers its interest in the purchase contract to be divided or split into equity shares as previously arranged and determined.

According to the terms of the Services Agreement, the real-estate closing agent is provided with closing instructions which provide for receiving from each of the prospective purchasers, the specified percentage of the purchase price (which is typically proportionate to the fractional interest purchased) as compensation, and particularly a monetary compensation, to administrators. In addition, administrators may receive a percentage interest in the property as non-cash compensation. The percentage interest received by administrators is an ownership interest and may be treated and exploited as such.

In addition, according to the terms of the Disclosure Memorandum and the Services Agreement, the real-estate closing agent is given instructions which provide for mutual acceptance by the prospective purchasers of the Declaration of Covenants at closing, which acceptance is preferably prior to or coincident with the passing of title to the property to the prospective purchasers, not owners. The Declaration of Covenants establishes the mutual benefits and obligations of the owners in furtherance of the protection of their property rights. Moreover, the Declaration of Covenants establishes a governance structure and provides for the amending of the same under certain conditions and if done as set forth. Some of the elements covered and set forth under the established governance structure include, but are not limited to, term, perpetuity, the establishment of an Executive Committee, management of the property, rights of ownership, possible consequences for violation or breach of obligations by an owner or administrators, and an agreed upon structure for coordinating the shared-use of the property.

### D. Forming Strategic Alliances with Real Estate Brokers/Agents

Real estate brokers and sales agents have a thorough knowledge of the real estate market in their respective communities. They are familiar with local zoning and tax laws and know the best place to obtain financing. Besides making sales, agents and brokers are deeply involved in locating, marketing, and acquiring properties to sell. Consequently, they spend a significant amount of time obtaining listings—agreements by owners to place properties for sale with them or the brokerage firm they represent.

The present invention features a unique method of utilizing real estate brokers and agents to locate prospective properties and to align these with prospective purchasers. With reference to FIG. 5, the present invention system comprises forming strategic alliances with one or more, and preferably several different, real estate brokers or agents, step 72. As part of the strategic alliance, and in return for a pre-determined or commission-based fee, administrators and real-estate brokers/agents coordinate efforts to carry out the present invention system, step 74, namely the sale of a suitable property to joint owners. This includes, but is not limited to, a coordinated effort to locate, market, and sell properties, a coordinated effort to locate and market to prospective purchasers, to align prospective purchasers with an available or prospective property, and to assist each other in the process of selling the prospective property, including the closing process.

An established relationship with one or more real estate brokers/agents provides a valuable tool that can help to propagate the present invention system, as well as function to reduce the costs to administrators required to operate the system. As stated, real-estate brokers and agents are extremely dynamic. They are familiar with local properties that may be sought after for joint ownership. In addition, real-estate brokers and agents are familiar with individuals around the community, state, or country that may be interested in becoming a joint owner of a more luxurious vacation property. Real-estate brokers/agents are also highly networked in that they have typically expended significant efforts to build and establish a client base and relationships with other key personnel in the business. In essence, the resources, dynamics, and networking capabilities of real-estate brokers/agents makes them a valuable tool. Moreover, the incentives provided by the administrators to the real-estate brokers/agents makes these established relationship a highly symbiotic one. The real-estate brokers/agents may also prove to be valuable resources when it comes time to complete a sale and execute the closing procedure.

As illustrated in step 76, and in addition to the services discussed above, a significant aspect of the established relationship between administrators and real-estate brokers/agents includes marketing the present invention system for the purpose of effectuating the purchase of a qualifying property by joint purchasers. Part of the marketing relationship allows the real-estate brokers/agents to affiliate themselves with administrators of the present invention for advertising and other purposes. For example, real-estate brokers may be authorized to provide a link to administrator's transactional activity center (typically an Internet web site) on their personal or company web site, that allows browsers of the real-estate broker's/agent's website to explore the administrator's web site through the provided portal, thereby being able to learn about the present invention property ownership system, to browse existing properties available for purchase, to register to become a prospective purchaser, and basically to become involved in the system as a potential client. In another example, the real-estate brokers/agents will be able to place the name, logo, contact information, or any other identifying indicia pertaining to the administrators or the system in their advertising materials, such as pamphlets, fliers, radio and newspaper ads, magazine ads, periodicals, and others. Other marketing scenarios are contemplated herein, as may be agreed upon by the parties involved. For example, large numbers of brokers and agents can participate in an on-line presentation where the incentives are fully explained. The cost of this electronic presentation tool may be borne by investors or other participants, such as a land title insurance company, which will greatly benefit from 1) the increased prospect of business development for their title insurance agents and, 2) the contractual promise of orders for title insurance and closing services.

The strategic alliance with real-estate brokers/agents further includes coordinating the purchase of a prospective or available property with a real-estate broker/agent, step 78. This step basically illustrates that the real-estate brokers/agents may be utilized to carry out the detailed procedures required to complete the sale of a property to a plurality of prospective purchasers as joint owners. Assistance may be provided in the closing procedures, in securing financing, in insuring the property, in making sure all documentation is in order, in setting up management of the property, and any other tasks needed to make the purchase as smooth as possible for the purchasers.

In the event a real-estate broker/agent completes a sale through the present invention system, step 80, such that the prospective purchaser working with the real-estate broker/agent becomes a joint owner of a property, the present invention system provides means for compensating the real-estate broker/agent, step 82. Compensation may comprise various forms, such as a pre-determined fee, a commission-based fee, or any other as agreed upon between the real-estate broker/agent and the administrators. The high, front-end monetary costs of operating the present invention system, such as locating properties, soliciting individuals to become prospective purchasers, advertising, etc. may be substantially mitigated through the created relationships and interactions between administrators and the real-estate brokers/agents. This may be accomplished by providing various incentives to real-estate brokers/agents, such as payment of a referral fee, located throughout regions of the U.S. or in other countries, as discussed above. The fees paid to real-estate brokers/agents are paid by administrators in return for the services rendered or for any referrals given. The fees may be paid by administrators using various funds, but preferably will be paid from the commissions received by administrators at the real estate closing. By doing so, some of the up-front marketing costs will have been shifted to more manageable and desirable back-end costs. Paying real-estate brokers/agents out of the commissions received by administrators at the closing of the purchase substantially minimizes the up-front costs that would normally be associated with utilizing such resources, while also allowing administrators to capitalize on the “gold mine” of personal contacts and other dynamics of the professional real-estate community. Incentivizing real-estate brokers/agents in this manner is unique to the present invention and not found in prior related business concepts or systems. More particularly, providing such incentives are not presently in place in the real estate community. The incentives method works in that brokers and agents will be motivated to justify their own marketing expenses to work their client bases and their market territories in light of the available earning potential. Despite potential for large gains, brokers/agents will more capably and cost-effectively access potential clients, as only incremental added marketing dollars will be expended. Providing incentives to real-estate brokers/agents allows administrators to minimize out-of-pocket marketing costs, while at the same time significantly increasing the ability to market the system. Clearly, fees to real-estate brokers/agents are dollars wisely invested to target audiences and propagate the system than other alternative marketing tactics. To be sure, providing incentives in this manner extends the reach of the system to potential clients, while also extending the marketing reach of real-estate agents looking for prospective property sales.

The implementation of an incentives package to real-estate brokers/agents is meant to be complemented by other tactical elements including, 1) print and web advertising, such as advertising in airline, in-flight magazines and, 2) professionally coordinated special events, such as invitational golf tournaments, and others as will be obvious to those skilled in the art.

If a sale is not completed, step 80, then no fee is provided to the real-estate broker/agent, step 84.

FIG. 6 illustrates a detailed diagram of an exemplary incentive arrangement provided to an affiliate real-estate broker/agent. Particularly, FIG. 6 illustrates an arrangement where the real-estate broker/agent personally refers a potential client to administrators. The referral may be provided using any known means. In FIG. 6, representative administrators are GrandShare, and the corresponding transactional activity center comprises a website having the URL grandshare.com. Once referred, the potential client accesses the public side of the transactional activity center, or web site owned and operated by the administrators. Once accessed, the potential client can investigate and research the system, look through the list of prospective and available properties, etc. to determine whether they would like to participate in the system. If not, the potential client may be instructed to notify administrators of his desire. Administrators may inquire as to whether the potential client may wish to be contacted again at a later time, in which case the potential client would be directed to provide relevant contact information.

In the event the potential client does wish to participate in the system, he or she undergoes the process to become a prospective purchaser, as discussed above. Once registered with the system as a prospective purchaser, the person becomes a client and can access the secure side of the transactional activity center. Here, the client assists in the development of a proprietary prospective purchaser database by providing market-sensitive and other information used by administrators in making prospective property suggestions or selections, and in aligning and/or partnering the prospective purchaser with other prospective purchasers having similar or compatible interest and preferences for ownership.

Within the private side of the transactional activity center, proprietary prospective property and available property databases are constructed and accessible only by existing and registered clients or prospective purchasers, as well as by administrators. These databases, which may be combined into a single property database, is developed through the cooperative contributions of real-estate brokers/agents submitting relevant property information, by administrators and their efforts to supply applicable property information, and by other means. Providing prospective purchasers access to the property database(s) functions as a qualifying or screening mechanism to further refine the purchase process and narrow and define the purchase possibilities.

FIG. 6 further illustrates that affiliated real-estate brokers/agents may also access another portion of the private side of the transactional activity center to monitor available incentives, potential incentives, the progress of purchases representing an incentive, and other details related to their involvement with the referred client. As indicated above, incentives are typically paid to real-estate brokers/agents after a referred client registers as a prospective purchaser and ultimately participates in the purchase of a property to become a joint owner of the property, irrespective of its location.

FIG. 7 illustrates a detailed diagram of another exemplary incentive arrangement provided to an affiliate real-estate broker/agent. Particularly, FIG. 7 illustrates an arrangement where the real/estate broker/agent owns and/or operates his or her own web site or web page within a web site. Once an established relationship is formed between administrators and the real-estate broker/agent, the real-estate broker/agent may be authorized to use the marks, logos, and other identifying indicia of administrators for marketing and other purposes. One particular advertising vehicle will be to place a link to the administrators web site on the web page of the real-estate broker/agent. Anyone browsing the real-estate broker's web site or web page will see and be able to select the link, which will take the user to the administrator's web site.

Other details illustrate in FIG. 7 are set forth above in the discussion pertaining to FIG. 6.

As described herein, the present invention establishes a strategic alliance with and within the worldwide real-estate broker community. The transactional activity center creates opportunities for access to online property offerings that are clearly outside the traditionally observed real-estate multiple listing parameters for purposes of 1) jointly-owned purchases, and 2) compensation above traditionally commensurate levels, regardless of the origin of professional license. In other words, real-estate brokers/agents are entitled to entire available commission fees despite their physical location. Thus, physical boundaries for real-estate agents and brokers are dissolved in favor of a more far-reaching alternative to traditional sales. Moreover, because a system for managing and maintaining real property is necessarily inherent to the proposition of jointly-owned real-estate, the present invention provides such a system, thus facilitating successful marketing by the broker.

### E. Managing the Use of the Purchased Properties

The present invention system and method further features coordinating the management and use of the properties purchased through the system for all of the owners involved. Although the ownership group will control the decision-making with respect to the property jointly owned by them, administrators may be asked to function as property managers for the ownership group. Property management services may be any commonly known in the art, such as interior and exterior maintenance, security, cleaning services, payment of financing obligations, payment of taxes, payment and monitoring of utilities and other bills, retainer of keys and codes. Administrators may also provide scheduling services to schedule the use of the property by the various owners, as well as others that may wish to use the property as authorized. Each of these tasks may be set forth in the executed Services Agreement and/or Declaration of Covenants.

In one exemplary embodiment, use of a purchased property is done on a rotating basis, where owners (partners) preferably have use of the property throughout all seasons of each year. Use during holidays is also rotated in order to maintain fairness. There are typically 4-6 partners whose use is governed by a Declaration of Covenants or Operating Agreement signed by the partners. A use schedule is attached to the Operating Agreement, but, a sample use schedule is shown in the Disclosure Memorandum made available prior to purchase. The use schedule may be advanced published annually or in any other increment of time so owners will always know when their use is scheduled.

Owners have a legal and practical interest in the overall management of their property. Operations and maintenance together with the payment of taxes and utilities are vital to preserving real estate investments. Additionally, coordinated and shared use is important to securing the desired enjoyment of vacation homes. Ownership of the property will preferably be through a company. It is through this company that owners of the property hold title to the property.

Administrators will provide a standard document to be adopted by owners. This document, the Declaration of Covenants (Covenants), is central to the formation of the limited liability company through which owners hold title. The Covenants set forth a method for creating a governance structure by which decisions are made as pertaining to the use and maintenance of the property as well as covering the cost of performing these functions. Administrators play an integral role as the overall manager of the property. Initially, Administrators function as the property managers, although owners are not foreclosed from making changes over the long-term.

Variation in use by all owners throughout each year will present numerous opportunities to engage the property in short-term rentals. Rental revenues are shared with owners and Administrators.

Bids by local property managers may be sought for costs pertaining to performing various operating and maintenance (O&M) tasks. These become the basis for preparation of O&M budgets to be adopted by owners in accordance with the terms of the Covenants. Owners are responsible for activity dues in association with property use and owners.

### F. Managing the Exchange of the Purchased Properties

The present invention system and method further features coordination by administrators of the exchange of the properties under its tutelage through a developed exchange program. Upon purchasing a property through the present invention system, each joint owner is given the opportunity to temporarily exchange his or her interest in the purchased property for use of another property in another desired location. Again, as each property within the present invention system must be a qualifying property, each property existing within the exchange system will be similar in price, luxury, exclusion, etc. to the property purchased by the various owners.

The exchange program comprises an elaborate system where owners, and therefore clients, may take advantage of other properties purchased in various locations throughout the world. The exchange program is preferably managed by administrators. In addition, administrators may or may not charge owners for such management services.

The exchange program is designed to increase in size and popularity as the pool of exchange properties increases. Although it will be encouraged, the participation in the exchange program may or may not be required by administrators. If required, this may be written into the relevant contracts entered into by purchasers at the time of closing, or may comprise a stand-alone contract.

Through its transactional activity center, administrators provide all of the necessary information and tools pertaining to the exchange of one or more properties. For example, through the transactional activity center, owners may access and view the database of available exchange properties, view schedules and contact information, initiate an exchange of all or a portion of their interest with one at another location, etc.

### G. Online Transactional Activity Center

As eluded to several times above, the present invention further features a transactional activity center configured to function as the focal center for all inquiries, transactions, activities, appointments, meetings, information to be learned or disseminated, status updates, relationships, notices, etc. related to the investigation of or use of the present invention system. The transactional activity center is preferably an online computerized transactional activity center utilizing a computer network, such as the world wide web or Internet, accessible by the public for general information about the system, by the prospective purchasers who have registered with the administrators, by real estate agents or brokers who also have registered, by third party affiliates that may be involved in a purchase transaction (e.g., title companies, insurance companies, etc.), by purchasers or owners of one or more vacation properties, and by the administrators. It is designed to be an easy to use center where all parties involved can come together to carry out or seek information about many of the aspects related to the participation in the system.

Following pre-screening, prospective purchasers will register at the transactional activity center, which is preferably a web site owned and operated by administrators. Personal information will be compiled in the various databases accessible through the transactional activity center. A real-time, real estate property database, instantly accessible by clients, will also be compiled on the web site. Growth of the real-estate property database will be facilitated and accelerated by administrators, clients, and particularly through the assistance of real estate brokers or agents involved.

The website is designed to be the center of transaction activity for the purchase of properties, use and management of properties, and the exchange of properties. Potential clients wishing to become prospective purchasers may register with administrators as discussed above, such as after an adequate pre-screening of the potential client.

Personal prospective purchaser and owner (otherwise client) information will be compiled various electronic databases and made available to authorized parties. A real-time, real-estate property database, accessible by clients and possibly others as dictated by administrators, will also be compiled. These databases will be developed by administrators, possibly through the assistance of real-estate brokers/agents.

Driving potential clients to the website is important and will be a focus of administrators and real-estate brokers/agents alike. Indeed, directing traffic to the website will be a primary objective of administrators and others.

As discussed above, the high, front-end monetary costs of developing, introducing, and managing the transactional activity center may be substantially mitigated through the real-estate broker/agent incentives program discussed above.

FIGS. 8 and 9 and the corresponding discussion are intended to provide a general description of an exemplary transactional activity center for centralizing the features and functions of the present invention property ownership system. One skilled in the art will appreciate that the invention may be practiced by a variety of computing devices and in a variety of system configurations, including in a networked configuration, as will be further explained below. In addition, one skilled in the art will recognize that the present invention transactional activity center may be modified and updated to comprise or feature other elements not specifically recited herein, but which are intended to be covered under the claims as provided below.

While those skilled in the art will appreciate that the invention may be practiced in networked computing environments with many types of computer system configurations, FIG. 8 represents an embodiment of the present invention in a networked environment that includes clients connected to a server via a network. While FIG. 8 illustrates an embodiment that illustrates three clients connected to the network, these shall be representative of the several clients that may be connected. Moreover, embodiments in accordance with the present invention also include a multitude of clients throughout the world connected to the network, where the network is a wide area network, such as the Internet.

Generally, FIG. 8 represents an exemplary embodiment of the present invention that enables the providing and execution of the several various embodiments of the present invention services. Specifically, in FIG. 8, server system 110 represents a system configuration owned and maintained by administrators for the purpose of providing the transactional activity center. Server system 110 may include one or more servers, each of which may be used to provide the online transactional activity center and execute the several various purchase, management, and exchange functions as described and claimed herein. By way of example, server system 110 may be a single server in cases where a single server can process and preserve the entire amount of information required to perform the methods of the present invention that are disclosed herein. Alternatively, server system 106 may be a conglomeration of servers that process and preserve a high volume of information.

In accordance with the illustrated embodiment, a potential or existing client may accesses a website in his/her own language to selectively seek out and gain information about the present invention system and administrators.

The following is a discussion of the illustrated embodiment of the present invention, which includes a plurality of clients, illustrated as clients 102, 104, and 106, connected to server system 110 across network 108 in order to provide the transactional activity center described herein. Network 108 may include a wireless network, a local area network, and/or a wide area network. In addition, server system 110 comprises all of the necessary components to operate the transactional activity center, such as a network interface 112 that interfaces with network 108, server processors 114, and one or more memory storage devices 116.

Clients 102, 104, and 106 also include a network interface (not shown), such as a web browser or other network interface. The network interfaces provided in clients 102, 104, and 106 are communication mechanisms that allow each respective client to communicate with server system 1 10 via the network 108 and to display information in the form of a web page on a display device. A browser allows for a uniform resource locator (“URL”) or an electronic link to be used to access the transactional activity center. Therefore, clients 102, 104, and 106 may independently access a web page that enables the exchange of information with server system 110.

Server system 110 includes network interface 112, application servers or processors 114, and storage device 116. Network interface 112 is a communication mechanism that allows server system 110 to communicate with one or more clients via network 108. Application servers/server processors 114 include one or more servers for processing and/or preserving information, and may be employed for providing and maintaining a web page that may be accessed by clients 102, 104, and 106. Storage device 116 includes one or more storage devices for preserving information, such as demographic information, professional information, customer information, billing information, or any other type necessary to the methods and systems disclosed herein. Storage device 116 may be internal or external to application servers 110.

Thus, a potential or existing client at one of the clients 102, 104, and 106 may access a web page maintained by one or more of the application servers 114 and access/submit information or communicate with other users. While the discussion above has presented a representative system configuration for implementing the present invention, those skilled in the art will appreciate that the methods of the present invention and processes thereof may be implemented in a variety of system configurations.

FIG. 9 illustrates a diagram of exemplary databases that may be developed and included in present invention system, and particularly provided via the transactional activity center. Specifically, FIG. 9 illustrates master data structure 120 as comprising a prospective purchaser database 122 (database of registered individuals wishing to jointly purchase a property), a purchaser/owner database 124 (database of existing clients who have already jointly purchased a property), a proprietary information database 126 (database of personal demographic and other pertinent or relevant information), an available property database 128 (database of properties for sale), a prospective property database 130 (database of properties looking to be offered for sale), a database 132 comprising properties sold (database of existing properties under contract or that have been purchased), an exchange database 134 (database of all information to facilitate the exchange of purchased properties), an administration information database 136 (database pertaining to administrators), a database 138 of useful third party entities (database of title companies, insurers, furniture suppliers, etc. that may be helpful to purchasers or prospective purchasers), and a real-estate brokers/agents database 140 (database of affiliated real-estate brokers/agents).

The present invention system comprises many advantages over prior related systems. First, there is less risk on purchasers. Risk is reduced because purchasers own title and equity, not a membership. Risk is also reduced as administrators place the property or properties under contract, at its risk. Ample time is given to consider all of the options. In addition, significant money and time is saved. Second, purchasers have the right to dispose of their interest however they may wish. For example, interests or time in the property can be used by the purchaser or rented, or exchanged. Should the purchaser wish to sell, they can. Third, partnerships are preferably formed with those having similar tastes and interests for location and amenities. Individuals are qualified prior to purchase and are matched based on similar factors, such as standards, specifications, desired location, price range, etc. Fourth, individualized tax circumstances can be accommodated.

### H. Competitive Comparison

For the purpose of validating the present invention business method, an exhaustive effort was made to find another business system in existence utilizing identical or similar system methods described herein. One such company was discovered, namely Exclusive Resorts, LLC. The business concept provided by Exclusive Resorts, LLC provides purchasers the ability to joint purchase high-end real estate. However, certain practices make this concept distinguishable from the present invention. The vital differences in this approach versus the present invention system is summarized in one word: risk.

The risk assumed by investors in Exclusive Resorts is evidenced by the business practice to purchase properties and then sell shares or interests in those properties, where investors purchase the properties upfront. Shares or interests acquired by participants are typically within a “charter” property. As such, the success of this system is based on the sale of shares. The differences between this concept and the present invention system are further identified as participants in Exclusive Resorts also assume risk by buying into a limited partnership rather than taking title to the specific property of their choice.

As advertised, Exclusive Resorts may offer a “guarantee” to buy back shares or memberships at the original purchase price (less 20% in the case of Exclusive Resorts) should participants decide to resign. However, it is acknowledged in each case that the strength of these guarantees is dependent on the viability and liquidity of the company.

The present invention system of providing equity to the purchaser in the property of his choice offers clearly distinctive re-sell advantages in receiving fair market value. Plus, the present invention system can help locate the purchaser, something not advertised by Exclusive Resorts. In the present invention system, it is intended that the remaining partners receive right of first refusal. Additionally, the present invention system contemplates providing a guarantee to re-purchase at a pre-determined percentage, such as 50%, of the original purchase price or a pre-determined percentage, such as 50%, of the fair market value, whichever is greater.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are expressly recited. Accordingly, the scope of the invention should be determined solely by the appended claims and their legal equivalents, rather than by the descriptions and examples given above.

1. A method for coordinating the purchase, exchange and management of jointly owned property comprising:
forming strategic alliances with one or more real estate brokers for the finding and acquisition of real property;
providing incentives to said real estate brokers for their services;
establishing a transactional activity center comprising databases of prospective purchasers, purchasers, and properties and information related to each of these;
matching at least one prospective purchasers with at least one other prospective purchaser and at least one said property to be jointly owned by said prospective purchasers;
coordinating and managing the sale and purchase of said property;
establishing an entity through which said joint owners in said property hold title to said property;
coordinating the establishment of customized covenants to govern use and ownership of said property between said joint owners; and
coordinating and managing the exchange of properties between said purchasers and others.
